(19) United States
(12) Patent Application Publication
(10) Pub. No.: US 2025/0182620 A1
(43) Pub. Date: Jun. 5, 2025

(54) Passive In-Vehicle Sensing of Pavement Signage Coded on Roadways

(71) Applicant: The Board of Trustees of the University of Illinois, Urbana, IL (US)

(72) Inventors: Jeffery Raphael Roesler, Champaign, IL (US); Apidej Sakulneya, Urbana, IL (US)

(21) Appl. No.: 18/919,813

(22) Filed: Oct. 18, 2024

Related U.S. Application Data
(60) Provisional application No. 63/591,657, filed on Oct. 19, 2023.

(51) Int. Cl. G08G 1/0967; B60Q 5/00; B60Q 9/00; E01F 9/30

(52) U.S. Cl. CPC G08G 1/096766; B60Q 9/00; E01F 9/30; B60Q 5/005

(57) ABSTRACT

This disclosure generally relates to signage and sensing schemes for roadways and particularly relates to passive in-vehicle sensing of signages coded on or embedded in road surface or pavement for enhancing roadway safety. In some example implementations, an array of sensors may be arranged in a vehicle. These sensors may be configured to interact with electromagnetic signatures of surface signages to generate detected waveforms, which may be analyzed to generate instructions or warnings to the drivers of the vehicle for altering unsafe driving maneuvers or for responding to upcoming work zones. Various instructions (e.g., slow-down instructions, merging instructions, and the like) or warning information may be associated with features spatially coded in the surface signages patterned on or embedded in the surfaces of the pavement over the roadway. These signages may be designed for construction work zone safety. These signages, for example, may be patterned using electromagnetic materials with local magnetic field and or electric field that can be detected and spatially resolved by the in-vehicle sensors via short-range electromagnetic induction and interactions. Such signage patterns may be formed by spatially arranged strips of such an electromagnetic material.

### CROSS REFERENCE

This application is based on and claims the benefit of priority to the U.S. Provisional Patent Application No. 63/591,657 filed on Oct. 19, 2023, which is incorporated by reference in its entirety.

### GOVERNMENT SUPPORT

This invention was made with government support under 69A3551747105 awarded by the U.S. Department of Transportation. The government has certain rights in the invention.

### BACKGROUND

### Technical Field

This disclosure generally relates to signage and sensing schemes for roadways and particularly relates to passive in-vehicle sensing of signages coded on or embedded in road surface or pavement for enhancing roadway safety.

### Background Technologies

Roadway signage designs are usually based on visualization by drivers. However, drivers of vehicles may not always be able to timely pick up such visual signages. An alternative deployment and detection scheme may be designed to augment the traditional roadway signages. Such alternative scheme may be particularly useful for signs and alerts related to roadway construction work zones.

### BRIEF SUMMARY

This disclosure generally relates to signage and sensing schemes for roadways and particularly relates to passive in-vehicle sensing of signages coded on or embedded in road surface or pavement for enhancing roadway safety.

In some example implementations, an array of sensors may be arranged in a vehicle. These sensors may be configured to interact with electromagnetic signatures of roadway/pavement surface signages to generate detected waveforms, which may be analyzed to generate instructions or warnings to the drivers of the vehicle for altering unsafe driving maneuvers or for responding to upcoming work zones. Various instructions (e.g., slow-down instructions, merging instructions, and the like) or warning information may be associated with features spatially coded in the signages patterned on or embedded in the surfaces of the pavement over the roadway. These roadway/pavement surface signages may be designed for construction work zone safety. These signages, for example, may be patterned using electromagnetic materials with local magnetic field and or electric field that can be detected and spatially resolved by the in-vehicle sensors via short-range electromagnetic induction and interactions. Such signage patterns may be formed by spatially arranged strips of such an electromagnetic material.

### BRIEF DESCRIPTION OF THE DRAWINGS

This patent or application file contains at least one drawing executed in color. Copies of this patent or patent application publication with color drawing(s) will be provided by the Office upon request and payment of the necessary fee.

FIG. 1 illustrates example roadway lane division and example areas of a roadway construction work zone.

FIG. 2 shows scenarios for the in-vehicle-warning system assessment.

FIG. 3 Illustrates example speed profiles of simulated scenarios for the in-vehicle warning-system assessment.

FIG. 4 Illustrates a distribution of lane-changing position of simulated scenarios for the in-vehicle warning-system assessment.

FIG. 5 Illustrates example applications of dynamic lane-merge systems (for right-lane closure).

FIG. 6 Illustrates an example right-lane-closure layout recommendation on work-zone speed-feedback systems.

FIG. 7 illustrates an example electromagnetic (EM) signature generated by embedding EM material.

FIG. 8, illustrates representation of example embedded EM signatures captured by array of EM sensors.

FIG. 9A shows vehicle lateral-position error for camera-based advanced driver-assisted systems (ADAS) under different weather conditions.

FIG. 9B shows vehicle lateral-position error for EM-based, passive-sensing system under different weather conditions.

FIG. 10 illustrates a schematic of an example in-vehicle speed-warning system for smart construction work zones.

FIG. 11A and FIG. 11B shows flowcharts of example in-vehicle speed-warning systems for smart construction work zones.

FIG. 12 shows a schematic of an example lane-merge warning system for smart construction work zones.

FIG. 13A and FIG. 13B show a flowcharts of example lane-merge warning systems for smart construction work zones.

FIG. 14 shows a schematic of an example experimental setup for EM passive-sensing warning system for safe construction work zones.

FIG. 15 illustrates reference numbers for example magnetometer sensor arrays.

FIG. 16A illustrates experimental setups for example EM-sensing strips placed perpendicularly to sensor arrays.

FIG. 16B illustrates experimental setups for example EM-sensing strips placed with an inclination angle to sensor arrays.

FIG. 17A illustrates EM passive-sensing response for stripes perpendicular to traveling direction with 1-ft strip spacing (EM sensor placed at shaded areas.

FIG. 17B illustrates EM passive-sensing response for stripes perpendicular to traveling direction with 2-ft strip spacing (EM sensor placed at shaded areas.

FIG. 17C illustrates EM passive-sensing response for strips at 45° angle to traveling direction with 1-ft strip spacing.

FIG. 17D illustrates EM passive-sensing response for strips at 45° angle to traveling direction with 2-ft strip spacing.

FIG. 17E illustrates EM passive-sensing response for strips at 60° angle to traveling direction with 1-ft strip spacing.

FIG. 17F Illustrates EM passive-sensing response for strips at 60° angle to traveling direction with 2-ft strip spacing.

FIG. 17G illustrates EM passive-sensing response for strips at 120° angle to traveling direction with 2-ft strip spacing.

FIG. 17H illustrates EM passive-sensing response for a strip at 60° angle to traveling direction and a strip perpendicular to traveling direction.

FIG. 18A illustrates a mechanism for detecting moving direction of a vehicle relative to the road.

FIG. 18B illustrates differences in detected traces between x sensors and z sensors.

FIG. 18C illustrates detected traces by x sensors at different locations in the vehicle when approaching a magnetic strip arrangement illustrated at the bottom of the figure.

FIG. 18D illustrates detected traces by z sensors at different locations in the vehicle when approaching a magnetic strip arrangement illustrated at the bottom of the figure.

FIG. 19 shows an example in-vehicle passive-sensing warning system.

### DETAILED DESCRIPTION

Various aspects for pavement signage sensing schemes will now be described in detail hereinafter with reference to the accompanied drawings, which form a part of the present disclosure, and which show, by way of illustration, various example implementations and embodiments. The systems, devices, and methods for sensing and processing of roadway/pavement surface signages disclosed herein may, however, be embodied in a variety of different forms and, therefore, the disclosure herein is intended to be construed as not being limited to the embodiments set forth below. Further, the disclosure may be embodied as methods, components, and/or platforms in addition to the disclosed devices and systems. Accordingly, embodiments of the disclosure may, for example, take the form of hardware, software, firmware or any combination thereof.

In general, terminology may be understood at least in part from usage in its context. For example, terms, such as “and”, “or”, or “and/or,” as used herein may include a variety of meanings that may depend at least in part upon the context in which such terms are used. Typically, the term “or”, if used to associate a list, such as A, B or C, is intended to mean A, B, and C, here used in the inclusive sense, as well as A, B or C, here used in the exclusive sense. In addition, the term “one or more” or “at least one” as used herein, depending at least in part upon context, may be used to describe any feature, structure, or characteristic in a singular sense or may be used to describe combinations of features, structures or characteristics in a plural sense. Similarly, terms, such as “a”, “an”, or “the”, again, may be understood to convey a singular usage or to convey a plural usage, depending at least in part upon context. In addition, the term “based on” or “determined by” may be understood as not necessarily intended to convey an exclusive set of factors and may, instead, allow for the existence of additional factors not necessarily expressly described, again, depending at least in part on context.

Many other modifications of the implementations above may be made to adapt a particular situation or material to the teachings without departing from the scope of the current disclosure. Therefore, it is intended that the present methods and systems not be limited to the particular embodiments disclosed, but that the disclosed methods and systems include all embodiments falling within the scope of the appended claims.

### Roadway Signage and Safety

Roadway signages are installed to inform drivers of various rules, lane divisions, road conditions, driving directions, alerts, and the like. Roadway signages may include persistent and temporary signs. Roadway signages may include either road side or above-road signs or on-surface indicators. Roadway signages are traditionally designed for driver visualization and recognition and rely on driver response to visual observation of the signs to achieve the various roadway safety goals.

Roadway signages are often temporarily installed. For example, construction work zones in roadways are often put in place temporarily during a period of construction. These signages are temporary in the sense that many drivers may not expect their presence, unlike other more persistent and more familiar roadway signs. they may be unexpected by many drivers.

Construction work zones are dynamic areas where road construction and maintenance activities take place. These zones present unique safety challenges due to the combination of ongoing construction activities, altered traffic patterns, and presence of workers and heavy machinery. Accidents in construction work zones can have severe consequences, including injuries, fatalities, and property damage. A substantial number of fatal accidents occur within construction work zones every year, making it a critical area of concern for transportation agencies and policymakers. Ensuring the safety of both workers and road users is a critical priority within construction work zones. Understanding the background and key factors contributing to work-zone accidents is essential for developing effective strategies to enhance safety. While the disclosure below refers to construction work zones, the term “construction work zones” broadly refers to any areas on or by a roadway designated for construction, maintenance, and other purposes, and that are closed for normal vehicles for any length of time duration.

Several factors influence accidents in construction work zones. Driver behavior is a significant contributor, with speeding, distracted driving, and improper lane changes being common causes of accidents. Traffic congestion in construction work zones can also increase the likelihood of collisions. Inadequate signage or improper signage placement can further contribute to accidents by failing to provide clear instructions to drivers.

In regard to the fatality rate in construction work zones, vehicle speed plays a crucial role, with higher speeds increasing the severity of accidents. The types of vehicles involved in work-zone accidents, such as passenger cars, commercial trucks, or construction vehicles, can also impact the fatality rate. The nature of collisions, such as rear-end crashes involving heavy vehicles, influences the likelihood of fatalities.

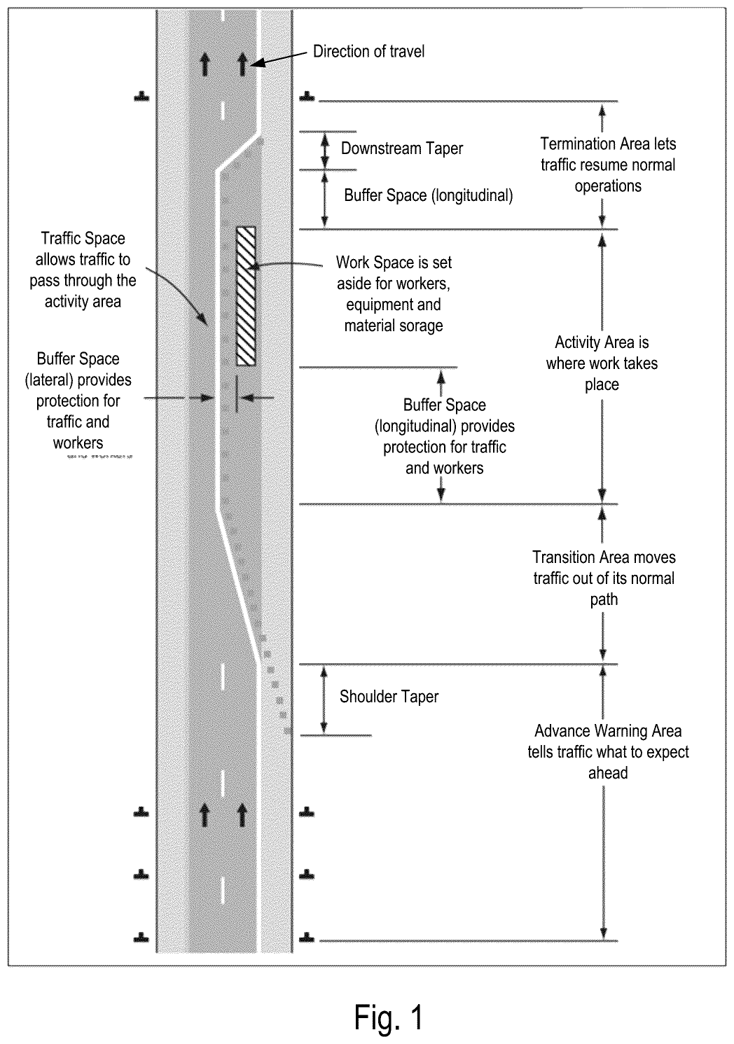

FIG. 1 illustrates an example roadway arrangement leading to a construction work zone including various designated regions. For example, the construction work zone of FIG. 1 may be divided into four example areas: the advance-warning area, the transition area, the activity area, and the termination area. As described in FIG. 1, the purpose of the advance-warning area is to notify road users about an upcoming hazard zone; whereas the transition area redirects vehicles from their normal path. The activity area is the specific roadway section where the maintenance or construction work is being performed, and the termination area indicates the point at which drivers completely exit the construction work zone and resume their normal driving speed and lane-changing options.

To mitigate accidents and enhance safety in construction work zones, various safety measures have been implemented. For example, rumble strips are installed on the pavement to produce vehicle vibration and audible warnings to alert drivers of an upcoming construction work zone. Warning signs placed in strategic locations provide important information and instructions to drivers that guide them through the construction work zone safely.

### Smart-Work-Zone (SWZ) Systems

In some example implementations, besides safety measures described above, other example technologies such as enhance safety light detection and ranging (LIDAR), intelligent transportation systems including advance-warning systems and real-time traffic information have also been employed with real-time monitoring, data analytics, and dynamic traffic management to render Smart-work-zone (SWZ) systems.

For example, SWZ systems may be specifically designed to provide multi-facet real-time and accurate information of work zones to motorists, ensuring they are well-informed about road conditions. These systems may encompass various components, including variable-message signs, queue-warning systems, dynamic lane-merge systems, speed-feedback signs, and the like. By utilizing these technologies, SWZ systems enable drivers to receive timely updates regarding traffic flow, lane closures, detours, and potential hazards, thereby improving their awareness and enhancing overall safety for both drivers and road workers. Such information may be received ahead of time and way before work zones are in sight. The ability to access instantaneous and precise updates empowers drivers to plan their routes more effectively, consider alternative paths when necessary, and adapt to changing conditions within construction work zones. This approach not only reduces congestion but also contributes to smoother traffic management, minimal user delays, and increased driver awareness of the upcoming hazards. With their potential to optimize work-zone operations and improve the overall transportation experience, SWZ systems serve as a crucial tool in enhancing road safety.

As part of the SWZ systems, typical work-zone measures may be used, including traditional traffic signages, such as warning and speed limit signs, which visually alert drivers about impending construction work zones. Alternatively, or additionally, portable rumble strips may be employed to provide audible and vibratory warnings to drivers to promote driver attentiveness as they enter the construction work zone. Typically, these strips are 12-foot long, 4-inch wide, and ⅛-ich. thick, and may be colored orange for visibility. Such rumble strips may be attached to the pavement surface in a multi-strip configuration (e.g., six-strip configuration, spaced 18-inch apart). For another example, the introduction of speed displays with radar detection encourages drivers to follow construction-zone speed limit. An example speed display may include of a 24-inch LED display and a Ka-band radar detector. These displays monitor oncoming vehicles and may be configured to initiate a flashing strobe lamp or a siren (e.g., at 130-dB) when they detect a vehicle that exceeds the speed limit.

The effectiveness of speed displays and rumble strips in rural maintenance or construction work zones may be evaluated as compared to temporary work-zone signages such as “Road Work Ahead” and “Left Lane Closed Ahead” signs. Rumble strips were found to have a greater impact on trucks than cars, leading to a speed reduction of approximately 3 to 4 mph for trucks within the construction work zone area. The speed reduction in passenger vehicles was less significant. Speed displays were shown to generate speed reductions of 2 to 9 mph in passenger vehicles and 7 to 10 mph in trucks. The presence of speed displays also resulted in a reduction in the percentage of vehicles speeding in the advance-warning area. In general, the specific location of the speed display within the work-zone area influenced the magnitude of speed reductions observed at various sites. Although speed displays have a relatively short installation time of under 10 minutes, the high initial cost of these devices may limit their widespread application. Rumble-strip installations can take up to 40 minutes to install but cost less.

Driver inattention has been one of the most common factors that cause fatal accidents in construction work zones, and this limits the impact of speed displays and rumble strips. One alternative to external speed displays or rumble strips is an in-vehicle warning-message system, as part an SWZ system. This solution is able to warn the drivers directly in both an audio and visual form inside the vehicle, which may significantly increase driver attentiveness to work-zone warnings.

Effectiveness of such in-vehicle warning-system messages through, for example, smartphones has been investigated by, e.g., simulation. For example, simulated-driving study may be performed to assess drivers' performance in two different work-zone scenarios: (1) shoulder-closure and (2) lane-closure. In an example, multiple drives through these example construction work zones may be simulated, each time encountering different hazardous events and using different messaging interfaces to communicate these events. The messaging interfaces may include a roadside, portable, changeable-message sign (PCMS); a smartphone providing auditory messages only; and a smartphone displaying audiovisual messages. The work-zone events simulated during the drives may encompass common scenarios such as traffic slowdowns, lane closures, presence of heavy machinery, and workers ahead. The in-vehicle-messaging smartphone may be positioned either on the dashboard or in the passenger seat. Driving performance and subjective measures such as event recall, mental workload, user-friendliness, and eye-tracking metrics may be evaluated throughout the experiments. The analysis of the driving-simulation study data revealed that both in-vehicle message conditions outperformed the roadside signs in terms of key driving metrics such as speed deviation between work-zone vehicles and the standard deviation in lane changing. Additionally, the studies also show lower mental workload experienced by drivers, better usability, and higher recall of work-zone events when using the in-vehicle messaging systems, as compared to the roadside-sign condition. The eye-tracking data provided by the example studies also shows that drivers may be less likely to divert their gaze from the road when using the in-vehicle messaging systems, as they have to look away from the road to read the messages displayed on the roadside signs. The positive effects of in-vehicle messaging appeared to be more pronounced in the more challenging lane-closure route, suggesting that in-vehicle messages are particularly beneficial in demanding roadway conditions.

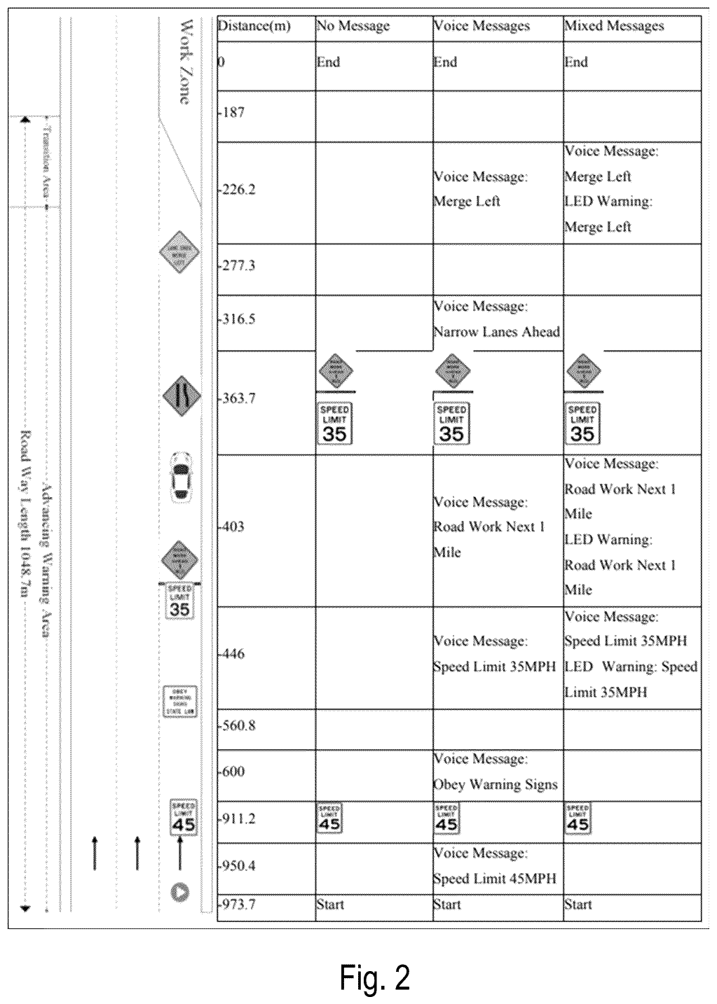

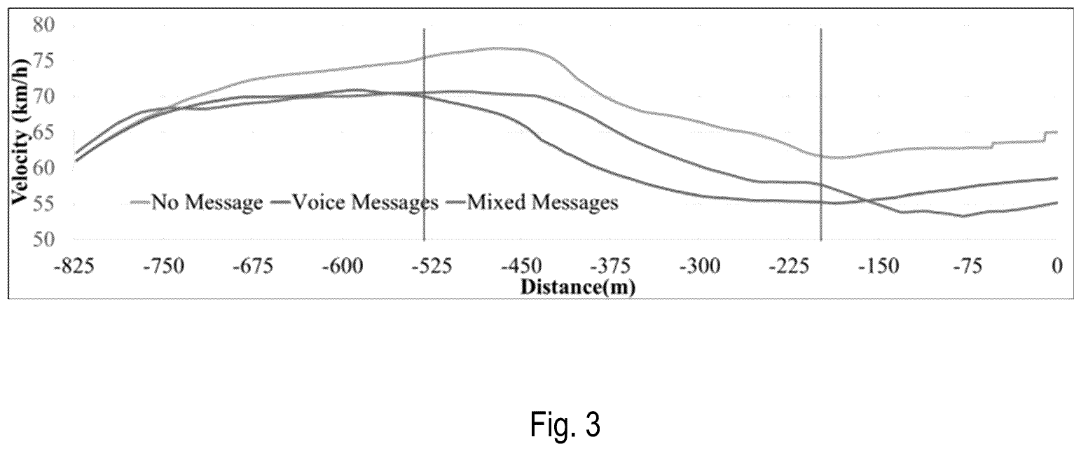

An example study for examining the effectiveness of an in-vehicle-messages warning system in the advance-warning area of a construction work zone in three simulated scenarios, as depicted in FIG. 2. The first scenario serves as a reference condition, simulating an absence of an in-vehicle warning system. In the second scenario, an audio in-vehicle warning system is incorporated. The third scenario involves the combination of both audio and visual in-vehicle warning systems. The velocity profiles of the three scenarios are depicted in FIG. 3 as a function of position in the advance-warning area (of FIG. 1). The first stage encompasses the area preceding the deceleration point, ranging from the starting point to −492 m. During this stage, a voice message is introduced, suggesting a speed limit of 45 mph or 72 km/h. Consequently, it is evident that the second and third scenarios exhibit lower speeds, as compared to the first scenario. As the vehicles progressed into stage 2, drivers across all scenarios receive a warning for a speed limit of 35 mph or 56 km/h. Notably, drivers in the second scenario demonstrate a prompt response in reducing vehicle speed, as compared to drivers in the third and first scenarios, respectively. Moving into stage 3, which commenced 166 m before the transition area (of FIG. 1), drivers in scenarios two and three maintain a relatively lower and consistent speed after hearing or seeing the warning messages. Conversely, drivers in scenario one appear more inclined to approach the transition area at speeds exceeding 35 mph.

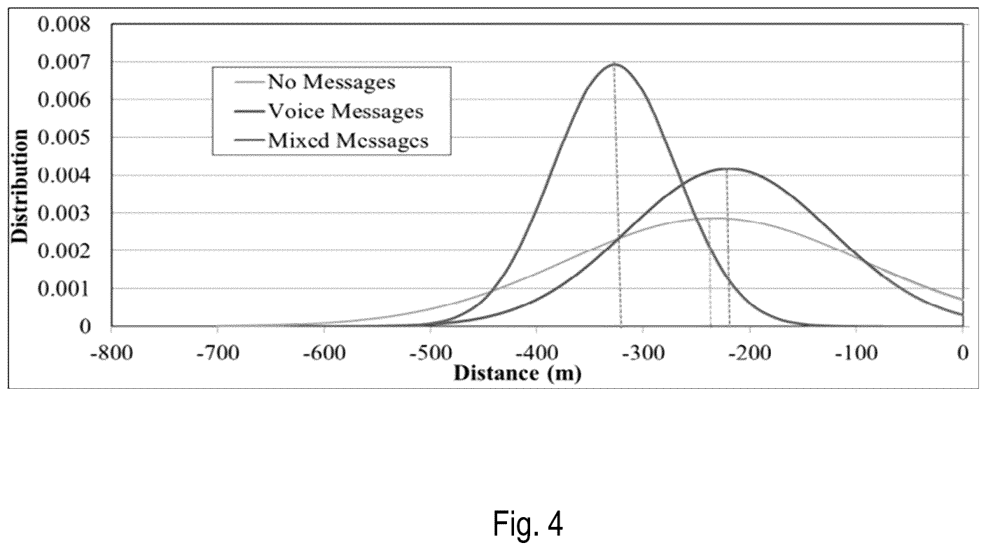

FIG. 4 provides an interpretation of lane-changing positions for the three scenarios above. Participants for the mixed-message scenario demonstrate lane changes at more concentrated positions (less deviation from the mean), indicating the effectiveness of combining auditory and visual cues. In contrast, the no-voice scenario exhibits greater variability in lane-changing positions, as presented in FIG. 4 with some drivers failing to merge before the end of the transition area. The investigation above highlights the importance of incorporating both in-vehicle auditory and visual alerts, especially in construction work zones, to improve lane-changing behavior and to a degree reduce vehicle speed.

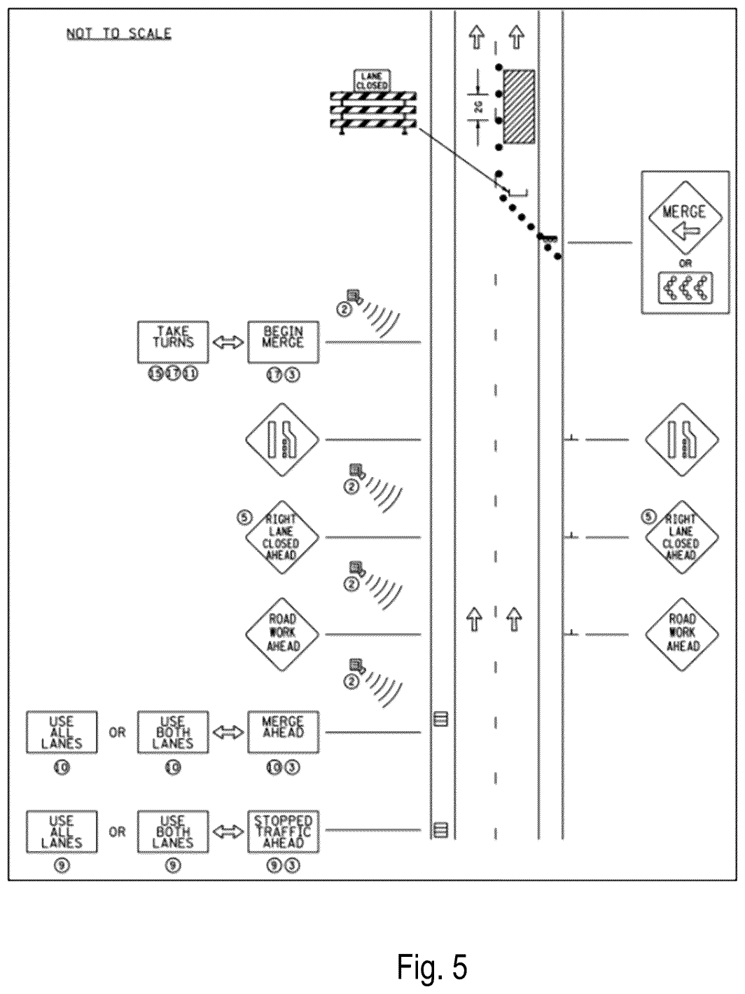

In addition, an exploration of the effectiveness and potential benefits of technologies such as dynamic lane-merge systems, speed-feedback sign systems, and hazard-intrusion warning systems is also essential for the development of future SWZ systems. For example, dynamic lane-merge systems may provide real-time information and guidance to drivers approaching lane closures with technology similar to variable message signs (VMS) and sensors. These systems promote efficient and orderly merging by dynamically adjusting the merging process based on real-time traffic conditions. By reducing congestion and improving traffic management, dynamic lane-merge systems result in greater traffic flow, reduced travel times, and enhanced overall safety within construction work zones. FIG. 5 presents an example layout for right-lane closure with dynamic lane merge. The activation and deactivation of the “Stopped or Slow Traffic Ahead” sign on portable, changeable-message signs (PCMS) can be automated. When the downstream sensor detects an average traffic speed drop of 20 to 25 mph below the posted speed limit, the “Slow Traffic Ahead” sign may be automatically activated. Conversely, when the average speed recovers and reaches within 10 mph of the posted speed limit or higher, the warning sign is deactivated automatically.

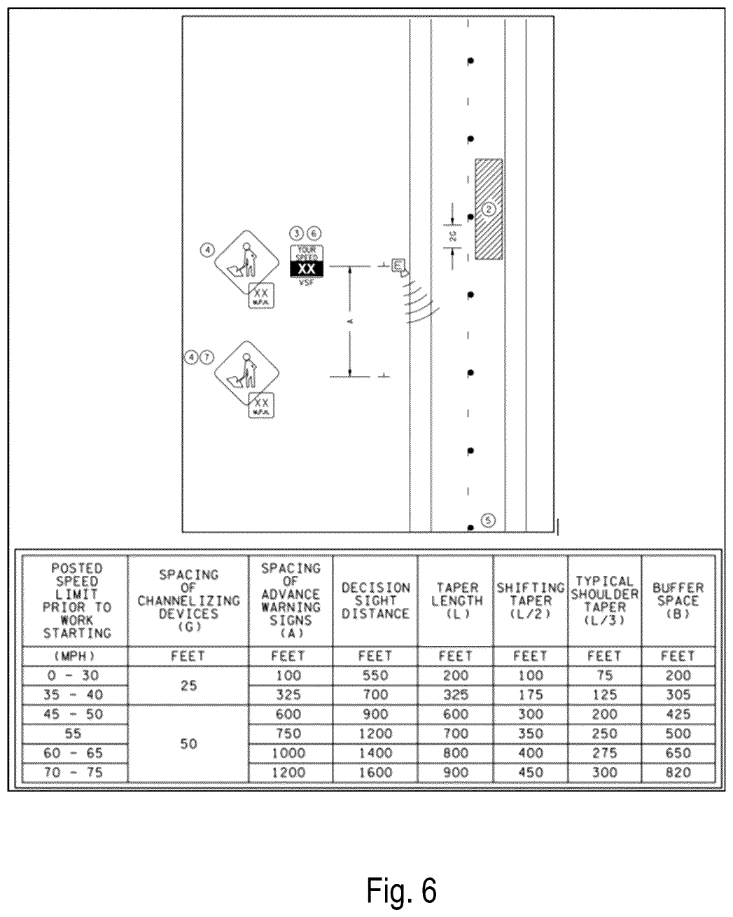

For another example, speed-feedback signs may be placed in construction work zones to display a driver's current speed and provide feedback on whether it exceeds the posted speed limit. These signs encourage motorists to maintain appropriate speeds and comply with posted speed limits. FIG. 6 illustrates an example work-zone layout incorporating speed-feedback signs.

For another example, an implementation of LiDAR systems may be a viable option for real-time detection and tracking of intruding vehicles within construction work zones, for the purposes of effectively predicting and warning construction workers about potential vehicle-intrusion threats in a SMZ system. LiDAR systems offer improved accuracy and provide workers with greater lead times to take necessary safety precautions.

Passive in-Vehicle Sensing for Lane Detection

In some example implementations, on-road vehicles may be installed with sensors and may be configured to communicate sensed information to other vehicles or a road assistance infrastructure. Such communications may be referred to as Vehicle-to-Vehicle (V2V) and Vehicle-to-Infrastructure (V21) communications, respectively. The infrastructure or a portion thereof, for example, may include the SWZ systems described above. Such V21 communication thus may be implemented to augment or assist the SWZ systems to enhance safety at or near construction work zones.

In some example implementations for V2V or V21 applications, as disclosed in further detail below, an array of sensors may be arranged in a vehicle. These sensors may be configured to interact with electromagnetic signatures of roadway/pavement surface signages to generate detected waveforms, which may be analyzed to generate instructions or warnings to the drivers of the vehicle for altering unsafe driving maneuvers or for responding to upcoming work zones. Various instructions (e.g., slow-down instructions, merging instructions, and the like) or warning information may be associated with features spatially coded in the signages patterned on the surfaces of the pavement over the roadway. These signages may be designed for construction work zone safety. These signages, for example, may be patterned using electromagnetic materials with local magnetic field and or electric field that can be detected and spatially resolved by the in-vehicle sensors via short-range electromagnetic induction and interactions. Such signage patterns may be formed by spatially arranged strips of such an electromagnetic material.

Such implementations essentially provide a passive sensing system that enables V2V and/or V21 communications by modifying the electromagnetic properties of the roadway to create a unique, detectable signature, enabling passive V21 communication. While sensing of on roadway/pavement surface signage may be alternatively performed by optical means such as the ones based on optical image capture and analysis via optical or infrared cameras, the sensing system based on electromagnetic interactions is advantageous in that, unlike a camera system, it is hardly affected by lighting conditions and weather conditions (e.g., snow coverage on roads).

Additional disclosure related to the electromagnetic materials that may be used in such V2V or V21 implementations can be found in U.S. patent application Ser. No. 18/368,866, entitled “Method of Maintaining Lateral Position of a Vehicle on a Roadway, Method of Configuring a Roadway for Lateral Position Sensing, and Paving Material Product,” filed on Sep. 15, 2023 by the same Applicant, which is herein incorporated by reference in its entirety.

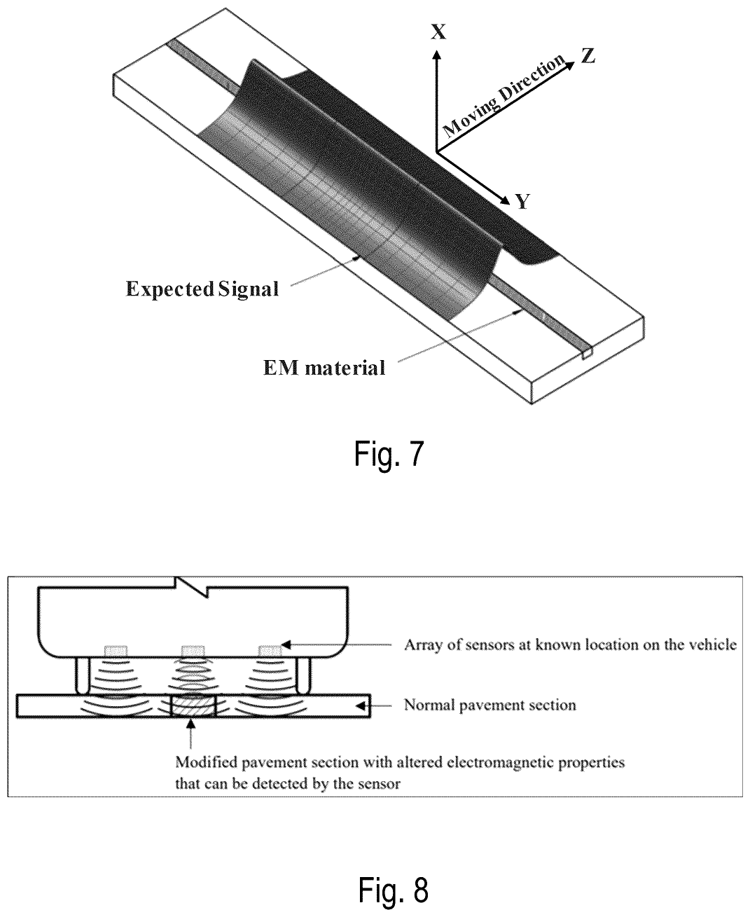

In some example implementations of such pavement-assisted, passive-sensing, the EM material embedded in roadways creates a continuous EM signature (e.g., static magnetic field), as shown in the example of FIG. 7. A lateral position of the vehicle in the lane may be tracked by an array of sensors such as magnetometers, as shown in FIG. 8.

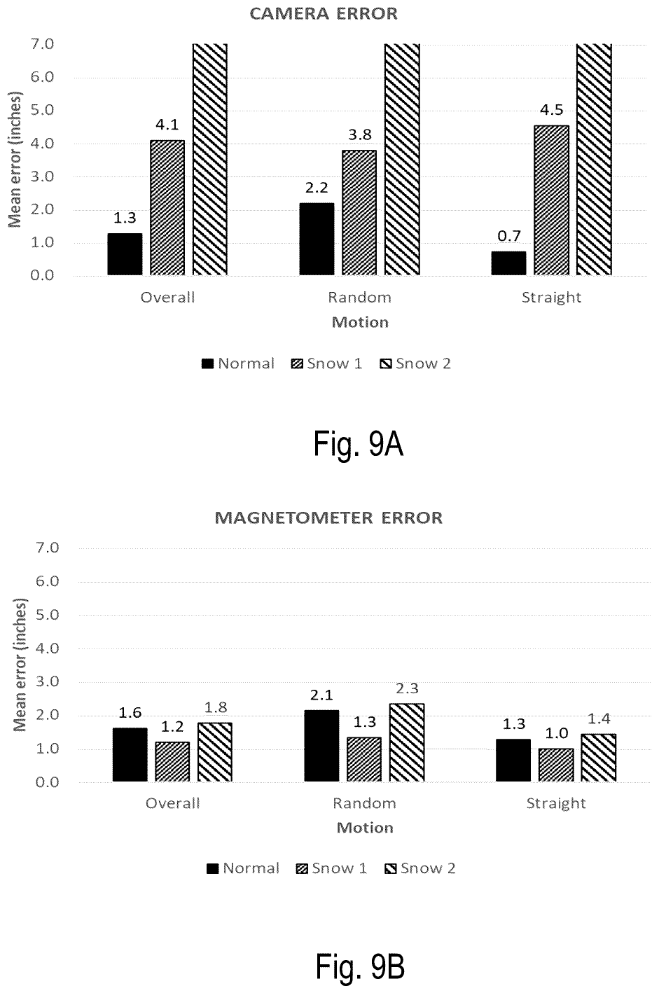

Such sensing system may be used in advanced driver-assisted systems (ADAS) for detecting, for example, lane position, and to help the vehicle stay in lane. As described above, such EM-signature ADAS system may outperform conventional camera-based, ADAS systems in vehicle lateral positioning under severe weather conditions or the lane markings are occluded (e.g., by shadows or lighting) or are not present. Example experimental measurements of detection errors in the camera-based ADAS system and the EM-signature ADAS are shown in FIG. 9A and FIG. 9B, respectively, as a comparison. FIG. 9A shows under less than 1 inch of snow on the lane (labeled as “snow 1”), the camera-based ADAS already has a significant increase in lateral-positioning error (4.1 inch), whereas FIG. 9B shows that the EM-based system maintained a relatively low error (1.2 inch). When the lane has over 2 inches of snow (labeled as “snow 2”), the camera system failed to perceive lane markings, as shown in FIG. 9A, while the magnetometer exhibited an overall error in lane detection of merely 1.8 inches, similar to normal weather and visibility conditions, as shown in FIG. 9B. FIGS. 9A and 9B thus demonstrate the reliability of the EM method to determine accurately the vehicle's lateral position in the lane, even in adverse weather conditions.

Passive in-Vehicle Sensing for SWZ

The usage of such sensing system is not limited to detection of lanes in ADAS systems. Such sensing system may also be used with the SWZ systems described above and in any other situations where information may be spatially coded or embedded on the roadway surfaces by using the EM material and detected with pattern recognition by the sensors installed on the vehicle. Control or instructional signals (e.g., visual or audio alerts to drivers, and actuation signal for vehicles) may then be generated based on the recognized pattern.

For construction work zone related sensing, the pavement surface of the road leading to the construction work zone may be temporarily installed or embedded with spatial pattern of the EM materials. Such spatial patterns, for example, may be used to signify upcoming construction work zone, suggested speed limit, lane merging, and the like. Such work-zone sensing, as incorporated in to in-vehicle warning systems have a distinct advantage over existing warning systems described above (such as posting roadside message signs), especially in adverse weather conditions. In-vehicle communication may be generated based on the EM sensing and can directly warn drivers through vehicle dashboard displays and/or audio messaging. With these alerts, drivers can receive real-time information about approaching construction work zones, which enables them to adjust their speed and safely merge into the appropriate lane. Merging indication or instructions can be further generated based on the EM sensing. The integration of pavement-assisted passive sensing into existing work-zone safety measures thus enhance driver awareness about the construction work zone and prepares for safe vehicle maneuvers when approaching the construction work zone. Further, V21 communications with passive pavement sensing in construction work zones would also lead to fewer accidents, injuries, and fatalities and also improve traffic flow.

### Passive In-Vehicle Sensing for SWZ-Example Implementations

Multiple functions for passive pavement sensing in construction work zones can be configured due to the ease with which EM signatures can be created in various positions and patterns. For example, a first function for exploring with the EM signature is to enable vehicles to be warned of their speed relative to suggested speed limit, via, for example, vehicle-detected and in-vehicle audiovisual warning. A second function for SWZ is to deploy passive EM-pavement sensing to provide an in-vehicle, lane-merge warning.

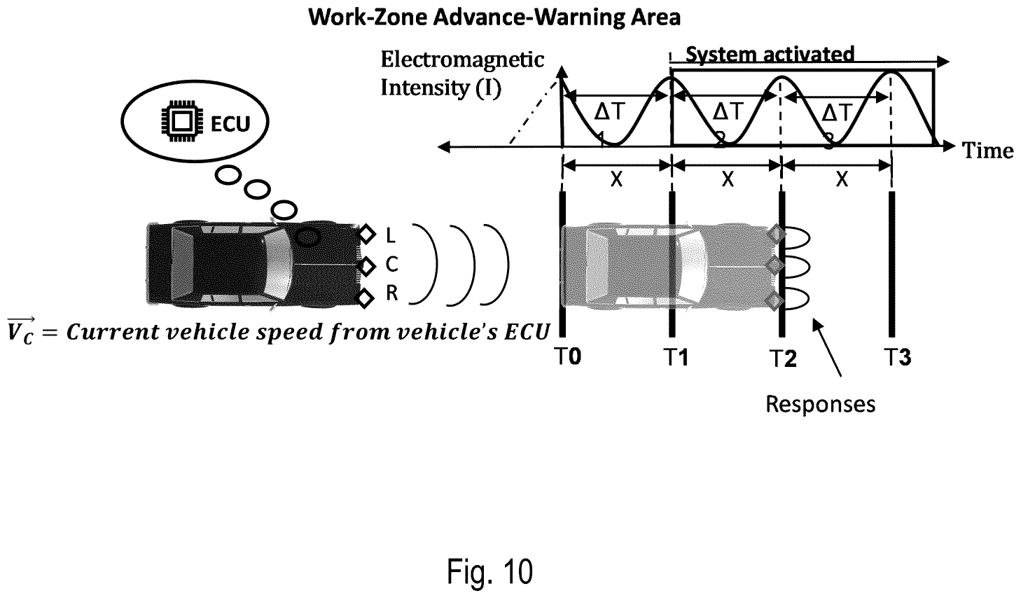

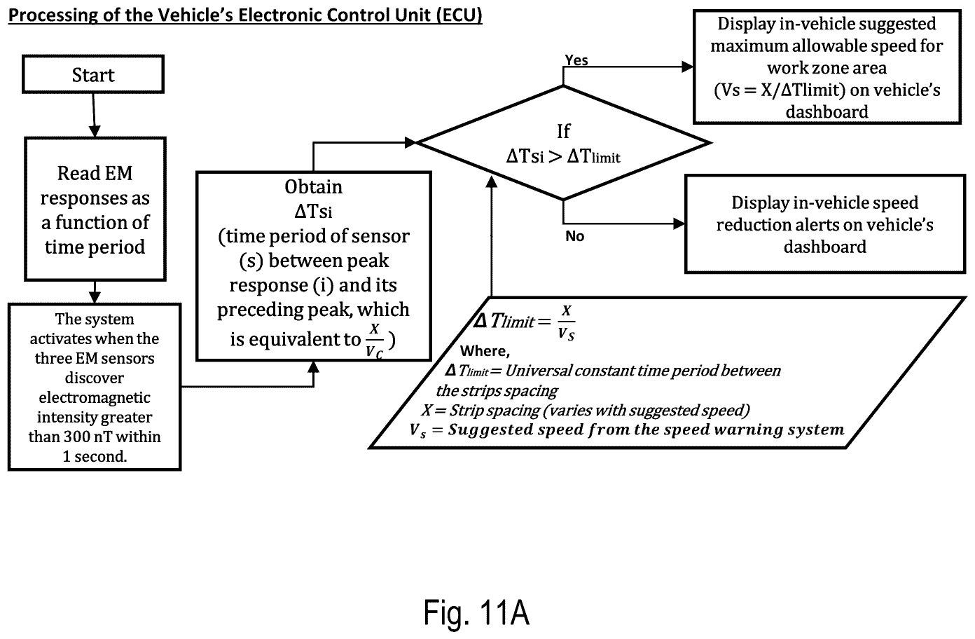

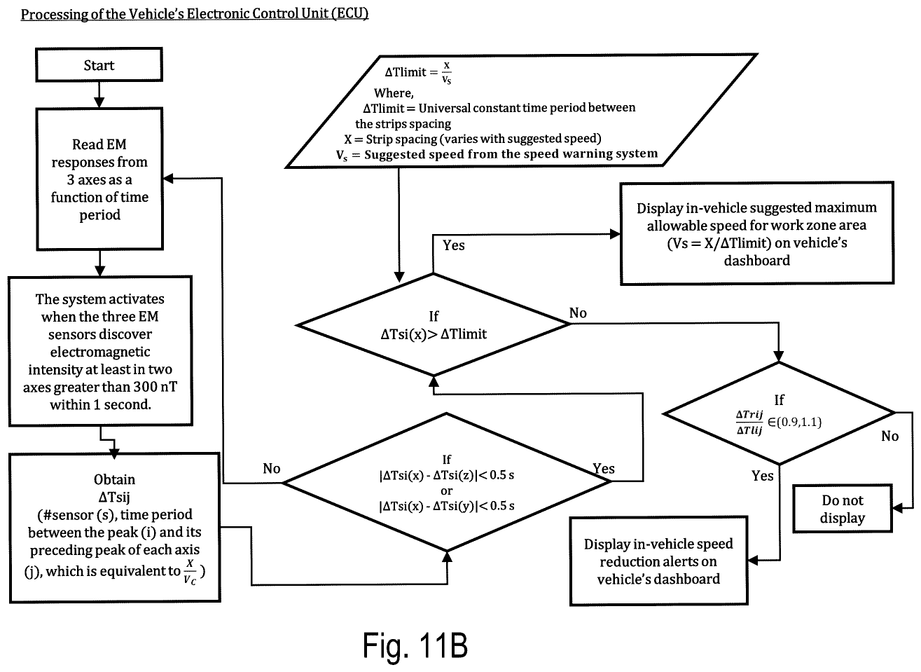

FIG. 10 and FIG. 11A show an SWZ schematic and a corresponding SWZ process, respectively, for an in-vehicle speed-warning system, which utilizes uniformly spaced (X distance, in the travel direction) EM strips perpendicular to the direction of travel. The electronic control unit (ECU) of the vehicle may serve as the main processing unit and activate the warning system when the EM sensors detect EM roadway signatures above the minimum detection threshold, with minimum number of road sensors during a limited time gap (e.g., at least 4 sensors detecting 300 nT changes in processed electromagnetic flux per data point, as shown in FIG. 11A. According to the example geometry arrangement of the EM strips in FIG. 10, the time interval (ΔT) between the EM response peaks for a particular in-vehicle sensor, as shown in FIG. 10 may be compared to a predefined period of time constant between the strips (ΔTₗᵢₘᵢₜ). By varying the EM strips' spacing (X) as a function of the work-zone speed limit (Vs, or suggested speed limit for the construction work zone), the measured time (ΔT) between strips is compared to the universal time constant, as shown in the procedure of FIG. 11A. Subsequently, the vehicle system can alert the driver through the vehicle dashboard when the driver exceeds the enforced speed limit. For example, the speed limit Vs for the construction work zone may be encoded in the spacing the EM strips via X=Vs·ΔTₗᵢₘᵢₜ. When the measured ΔT between peaks of a sensor is longer than ΔTₗᵢₘᵢₜ, then that indicates the vehicle is traveling below the speed limit, whereas when the measured ΔT is shorter than ΔTₗᵢₘᵢₜ, then that indicates the vehicle is traveling above the speed limit. In-vehicle display information may then be correspondingly adapted. For example, when the vehicle is traveling below the suggested construction work zone speed limit, the ECU may control the dashboard to display the suggested construction work zone speed limit Vs, whereas when the vehicle is traveling above the suggested construction work zone speed limit, the ECU may control the dashboard to display speed reduction alert with an amount of speed reduction, as shown in the process of FIG. 11A.

As shown in FIG. 10, multiple sensors may be installed in the vehicle, along a same lateral line (e.g., referred to as left, center and right sensors in FIG. 10). Each of these sensors in the example of FIG. 10 may detect similar sequence of EM peaks when pass the EM strips. Other geometrical arrangement of the sensors may also be used. These sensors may be fabricated in the form magnetometers. The measurement of ΔT in the implementation of FIG. 10 may be averaged between different sensors.

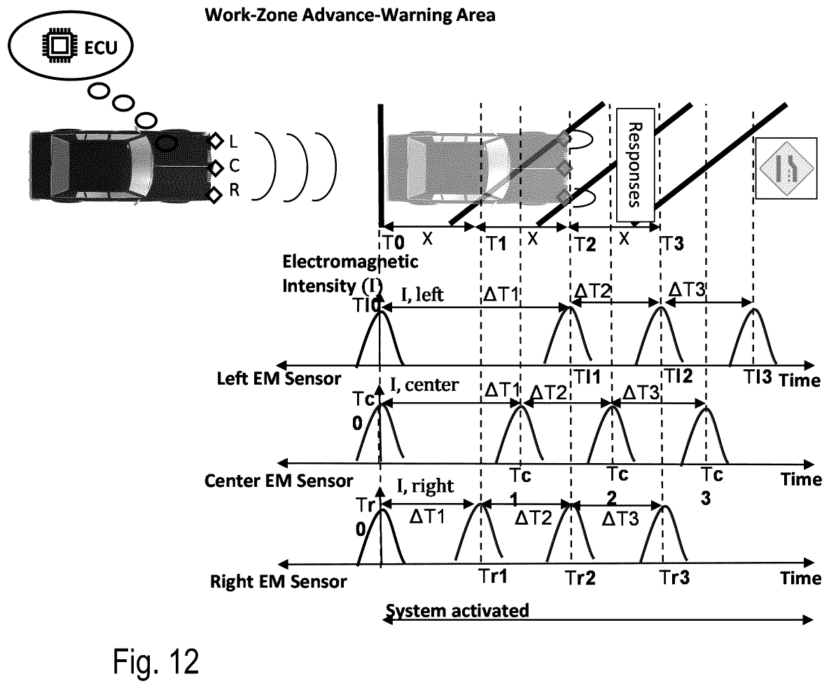

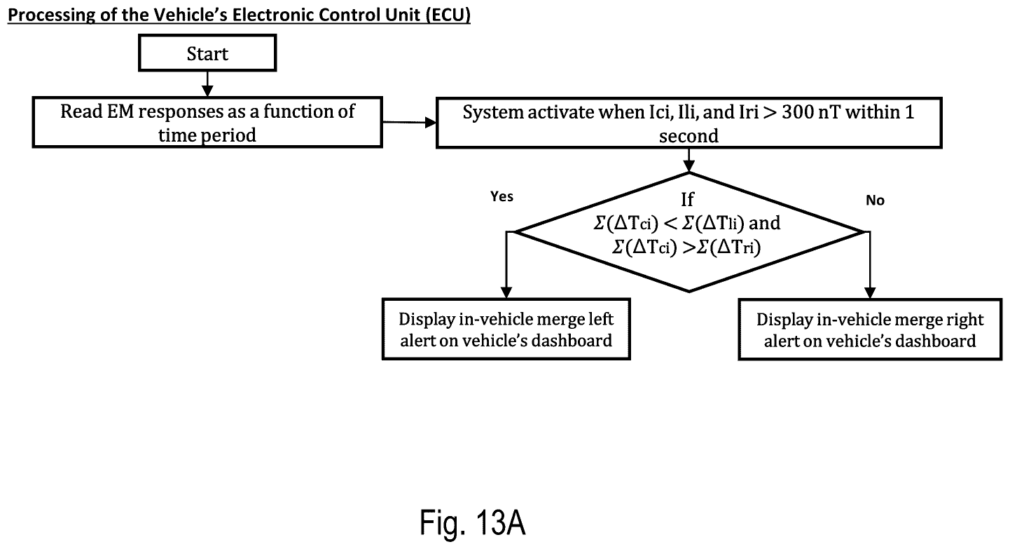

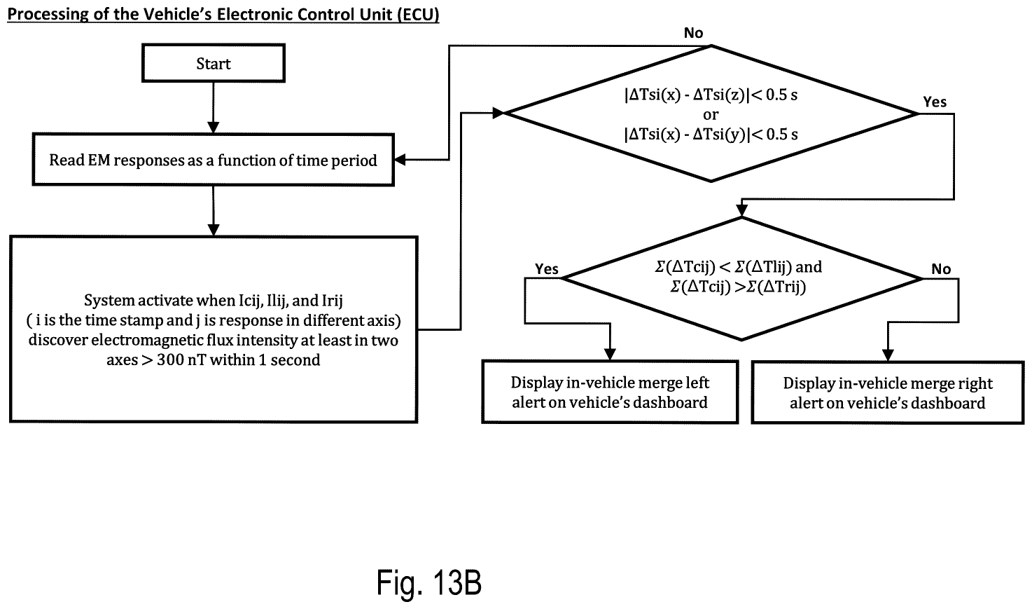

FIG. 12 and FIG. 13A shows another SWZ schematic and a corresponding SWZ process, respectively, for an in-vehicle lane-merge warning system using the passive EM pavement sensors. Similar to the speed-warning system of FIG. 10, the ECU serves as the main processing unit and activates this system when all EM sensors detect EM responses above the minimum threshold. However, the in-vehicle lane-merge warning system utilizes different EM signatures (or EM strip arrangement), as compared to the in-vehicle speed-warning system of FIG. 10. Specifically, the example EM strips in the lane-merge system of FIG. 12 are oriented in a slanted configuration (e.g., diagonal, or at other angles) rather than perpendicular to the direction of the vehicle movement.

In the example of FIG. 12, the passive sensors can be used to implement one or both of an in-vehicle speed-warning function and an in-vehicle lane-merge warning system function. As illustrated in FIGS. 12 and 13A, the in-vehicle lane-merge warning system can provide merging directions on the vehicle's dashboard through calculations involving the timing difference at the peak when all sensors have been triggered by exceeding threshold EM intensity. For example, the vehicle speed may be derived from inter-peak time difference from an individual sensor, and then the inclination direction may be derived from the sign of the timing different of the signal peaks between the multiple sensors, and the inclination angle may be derived from the timing difference of signal peaks between multiple sensors and the vehicle speed, as described in further detail below.

In the example of FIG. 12, three sensors (left, center, and right sensors) may be installed on the vehicle. For example, the three sensors may be installed in the same lateral plane of the vehicle. Similar to FIG. 10, each of the sensors may pass the EM strips sequentially as the vehicle travels along the roadway, thereby producing EM response with inter-peak time separation ΔT. Unlike FIG. 10, the three sensors there in FIG. 12 generate sequences of EM response that are shifted in time relative to one another. The amount of time shift depends on the inclination angle of the EM strips. The lane merge warning system function may be activated when responses for all three sensors begin to be detected and are all above the predetermined threshold (e.g., detected magnetic field higher than 300 nT). To account for the oscillation of the responses in real time, the activation may be based on response over the threshold within a time window of a predefined length (e.g., 1 second).

In some example implementations, all peak positions in time for each of the sensors may be identified, these peak time positions may be referred to as Tₛᵢ, where “s” identify the sensor, and the “i” represents the response peak index (corresponding to the EM strips). For example, the peak time positions are T_{I1}, T_{I2}, T_{I3}, . . . for the left sensor, T_{c1}, T_{c2}, T_{c3}, . . . for the center sensor, and Tᵣ₁, Tᵣ₂, Tᵣ₃, . . . for the right sensor. In one example, if the ECU determines that ΣᵢT_{ci}<ΣᵢTₗᵢ and ΣᵢT_{ci}>ΣᵢTᵣᵢ, indicating that the EM strips are slanted to the left in the travel direction, then it may generate a left merging warning, as shown in FIG. 13A. Otherwise, if the ECU determines that ΣᵢT_{ci}>ΣᵢTₗᵢ and ΣᵢT_{ci}<ΣᵢTᵣᵢ, indicating that the EM strips are slanted to the right in the travel direction, then it may generate a right merging warning. In some example implementations, each of the sensor of FIG. 10 and FIG. 12 may include 3-axis sensing functions. For example, each individual sensor may be capable of 3-axis sensing, e.g., implemented as a 3-axis magnetometer that captures unique and distinguishable responses from three different axes, x, y, and z, for improving reliability and accuracy of the detection above, as described in further detail below. In such implementations, correlated EM response in x, y, and z may be utilized. The signals in these axes may be rechecked to ensure accuracy before providing maneuvering instructions. Such reliance on responses from multiple axes reduces the risk of maneuvering instruction errors caused by unexpected noises from roadside devices or metallic materials on the road surface.

An example data and logic flow for using the scheme of FIG. 10 and 3-axis sensing for the speed-warning function is shown in FIG. 11B. In comparison to FIG. 11A, where ΔTₛᵢⱼ represents the time period between the i-th peak and its preceding peak, measured for the s-th sensor on the j-th axis. For example, ΔTₛᵢ(x), ΔTₛᵢ(y), and ΔTₛᵢ(z) in FIG. 11B represent peak periods measured in the x, y, and z directions respectively. In this disclosure, z represents the forward road direction, whereas x and y represent the vertical direction and the road width direction, as indicated in FIG. 7. In FIG. 11B, whether the period between peaks in a particular direction (e.g., ΔTₛᵢ(x), in the x direction) is larger or smaller than ΔTₗᵢₘᵢₜ is checked for generating speed-warning information only after the ΔTₛᵢ(x) is correlated with either ΔTₛᵢ(y) or ΔTₛᵢ(z) and the signals are checked and are verified as consistent or correlated. If they are not consistent (or correlated), the measurement is considered invalid and need to be retaken from the next segment of the on-road magnetic signature. The consistency check, for example, may involve determining whether the differentials between ΔTₛᵢ(x) and either ΔTₛᵢ(y) or ΔTₛᵢ(z) are smaller than a predefined threshold value, e.g., 0.5 s, as shown in FIG. 11B. In some example implementations, the speed warning information, particularly the speed reduction warning alert, is generated only when the ΔTₛᵢj corresponds to the peak period between the two consecutive strips having the same inclined angle. The fraction of the peak period between the left and right sensors must range within the threshold value (e.g., between 0.9 to 1.1) to avoid unintentional alerts, as shown in FIG. 11B,

Similarly, an example data and logic flow for using the scheme of FIGS. 12 and 3-axis sensing for the lane merging function is shown in FIG. 13B. In comparison to FIG. 13A, where ΔT_{ci}, ΔTₗᵢ, ΔTᵣᵢ respectively represent peak period measured for the i-th center, left, and right sensors, ΔT_{ci}(j), ΔTₗᵢ (j), ΔTᵣᵢ(j) in FIG. 13B represent peak periods measured for i-th center, left, and right sensor in j-th dimension, where j can be either one of the x, y, and z dimensions. ΔTₛᵢ(x), ΔTₛᵢ(y), and ΔTₛᵢ(z) in FIG. 13B represents the time period between the i-th peak and its preceding peak and can be for any one or combination or weighted combination for each of the x, y, z dimensions of the s-th center, left, and right sensors. In comparison to FIG. 13A, the determination of whether ΣᵢΔT_{cij}<ΣᵢΔTₗᵢⱼ and ΣᵢΔT_{cij}>ΣᵢΔTᵣᵢⱼ, for generating a left lane merging command, for example, is performed only after the ΔTₛᵢ(x) is determined as being correlated with either ΔTₛᵢ(y) or ΔTₛᵢ(z) (indicating that the signals are checked and verified as consistent or correlated). This may involve determining whether the differentials between ΔTₛᵢ(x) and either ΔTₛᵢ(y) or ΔTₛᵢ(z) are smaller than a predefined threshold value (e.g., 0.5 seconds), as illustrated in FIG. 13B.

In some implementations, each of the sensors of FIG. 10 and FIG. 12 may include a pair of two sensors that are installed at separate vertical positions, one closer to the ground plane for picking up the EM signature from the EM strips and the other further away from the ground plane for measuring background EM signals (e.g., from earth magnetic field). A differential of the pair of sensors may be used as a background-subtracted EM response for the speed warning and lane merging systems above. In some other implementations, a single background sensor may be shared by all sensors closer to the ground plane for detecting the EM signature.

In some implementations, the EM strips are spaced in a manner that the EM signatures of the adjacent EM strips do not significantly interfere or merge spatially. Also, even without significant spatial overlapping or merging of the EM signature of the EM strips, the EM strips may nevertheless to be arranged with sufficient spacing such that each in-vehicle sensor can resolve the sequence of peaks from the multiple EM strips even in the presence of possibly slow response time of the sensors (with their processing circuitry). In other words, the detection of a next EM strip is not indistinguishably buried in the detection of a preceding strip. Further details are provided below.

To optimize the strip configurations for the proposed in-vehicle speed and lane-merge warning systems in construction work zones, an experimental design may be tested. The objective of the lab testing was to verify the theoretical SWZ configurations with EM-based strips and to determine the suitable spacings and inclination angles for the EM strips for the speed and lane-merge warning systems, respectively. The experiment involved varying the strip spacings and inclination angles, while assessing the impact on the EM intensity at the sensors (e.g., magnetometer) and the calculated times between EM peaks.

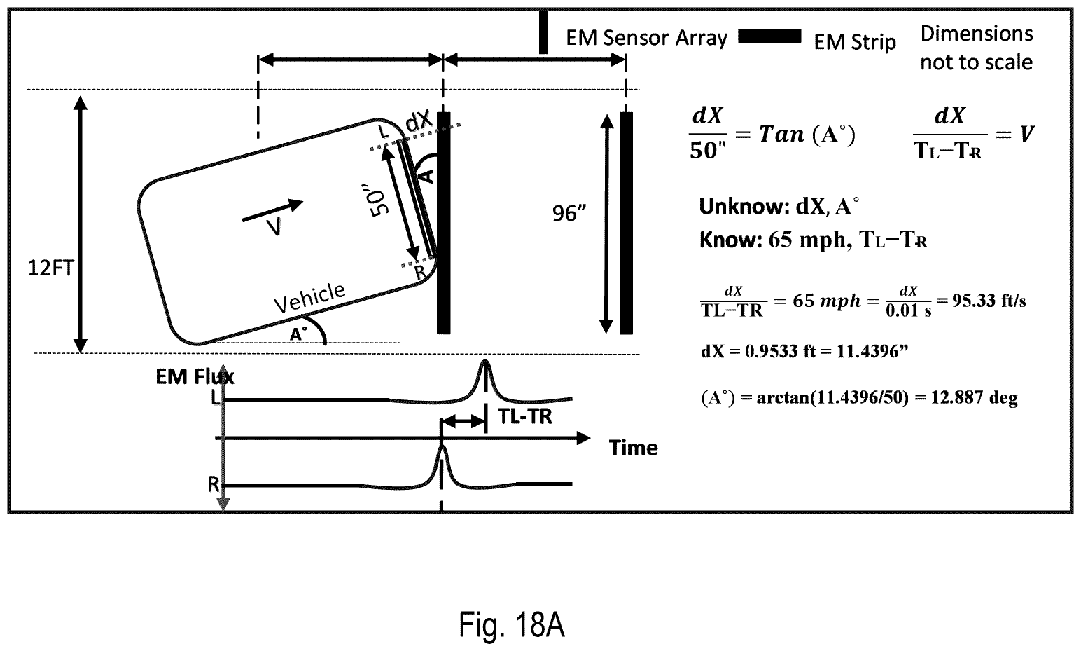

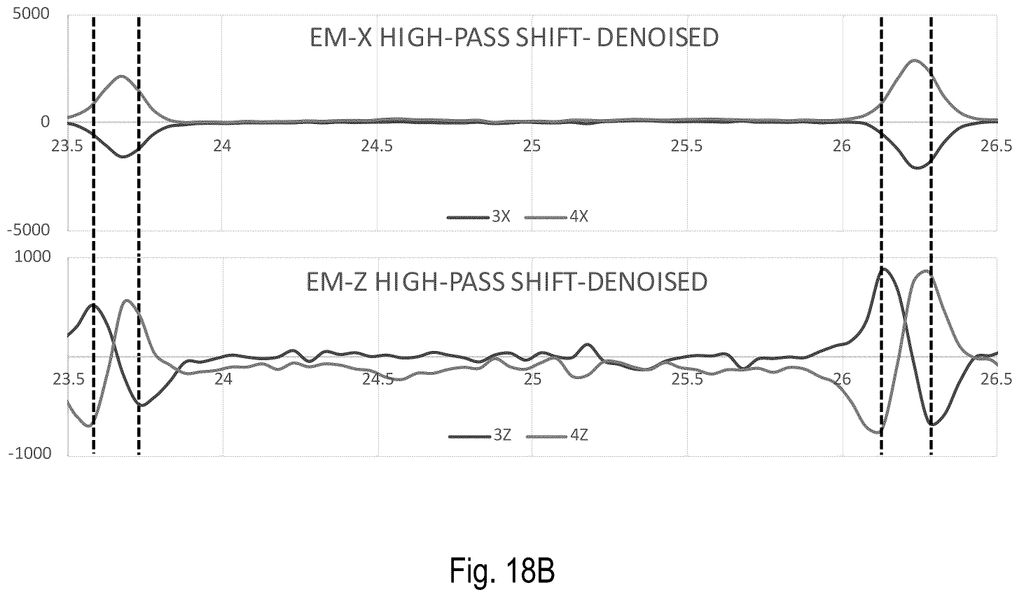

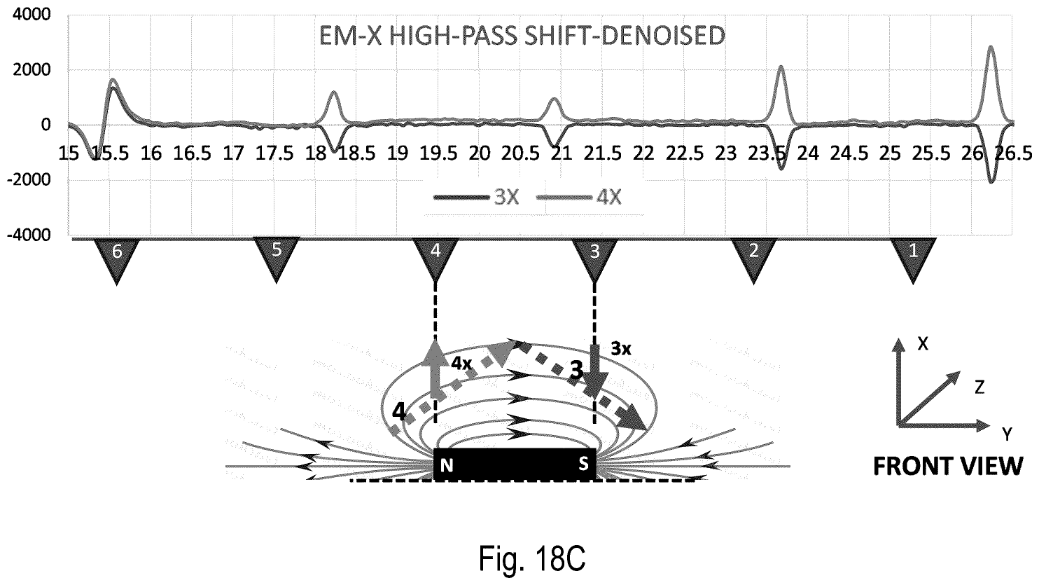

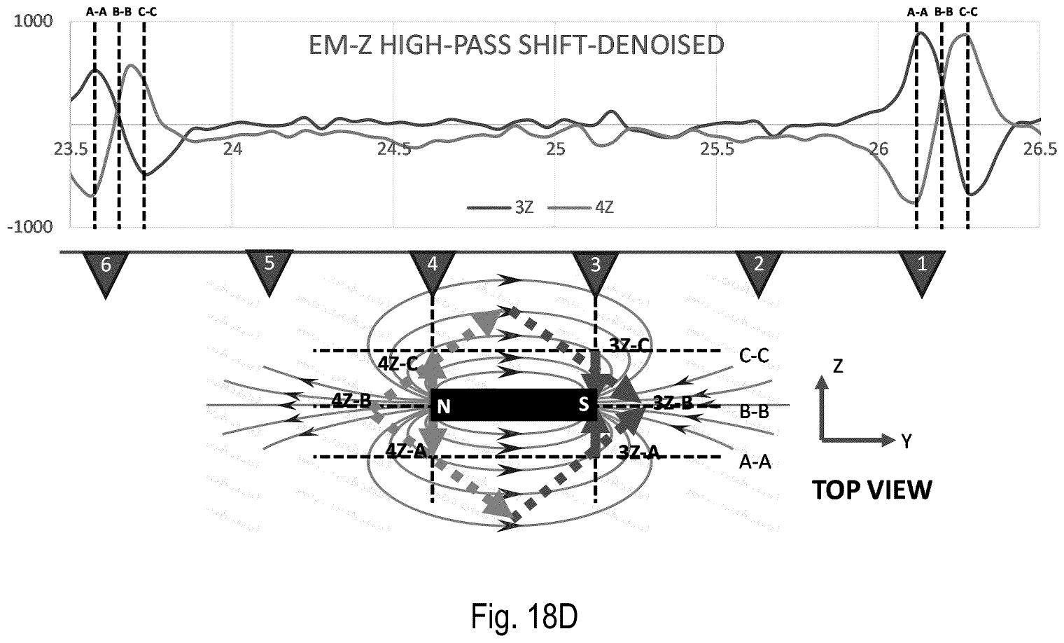

In some example implementations, the in-vehicle sensing system above may be used to detect the road signage signals in order to determine the direction of motion of the vehicle relative to the road, so as to provide to warning signal when the vehicle is veering off or about to veer off road, as illustrated in FIG. 18A. Particularly, in the configuration where the magnetic strip on the road is perpendicularly arranged to the forward direction of the road, if the vehicle moves at an angle to the forward road direction, e.g., to the left, then the right front corner of the vehicle may approach the magnetic strip first leading to the right sensor(s) of the vehicle detecting the signal first. As illustrated in FIG. 18A, the time difference between the onset of signal for the left and right corner sensors (TL-TR), the distance between the sensors, and the speed of the vehicle may determine the veering angle of the vehicle, which may be used to generate the veering-off warning signal. Example numbers are provided in FIG. 18A.

In addition, for magnetic strips arranged with polar direction perpendicular to the forward road direction, when 3-axis sensors are used, a z direction (see FIG. 7) sensor would pick up the signal ahead of the sensor approaching the magnetic strip, such that the left and right z sensors would be able to provide veering signal earlier than only using x or y sensors. This is illustrated in FIGS. 18B and 18D.

Specifically, FIG. 18B shows signal time trace of x and z sensors located at different lateral location of the vehicle (3 or 4). The signal traces show that z sensors at a same lateral location can detect signal onset earlier than the x sensors. The polarity difference between the x and z signals is due to the polarity configuration of the magnetic strip as further illustrated in FIGS. 18C and 18D.

FIG. 18C shows that, with the magnetic polarity arrangement as shown, the x sensors 4 and 3 passing in z direction through the two ends (north and south) of the magnetic strip would detect signal caused by the magnetic field in x direction as shown by the illustrated traces. FIG. 18D shows corresponding traces from the z sensors. The time positions in the trace indicated by the dashed lines correspond to the sensor positions (correspondingly labeled) along the moving direction of the vehicle shown in the bottom of FIG. 18D. Note that the z direction is in the plane of FIG. 18D but is pointing into the plane of FIG. 18C.

### Example Setup for Passive EM-Sensing Signatures

To optimize the strip configurations for the in-vehicle speed and lane-merge warning systems in construction work zones described above, various designs are tested. The objective of the test is to verify the above SWZ configurations with EM-based strips and to determine the suitable spacings and inclination angles for the EM strips for the speed and lane-merge warning systems, respectively. The designs involve varying the strip spacings and inclination angles, while assessing the impact on the EM intensity at the magnetometer and the calculated times between EM peaks.

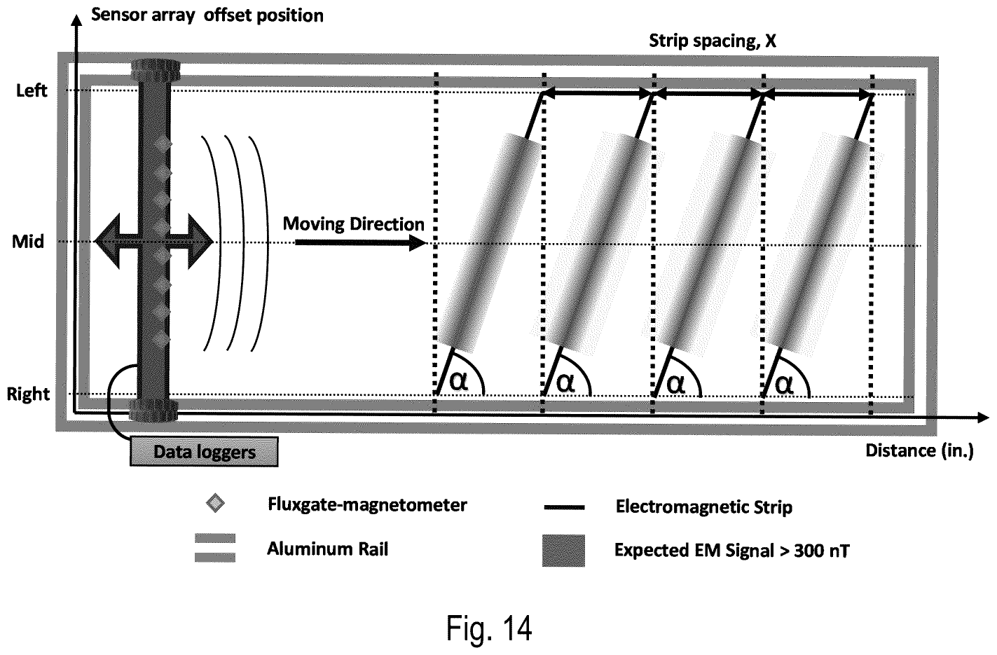

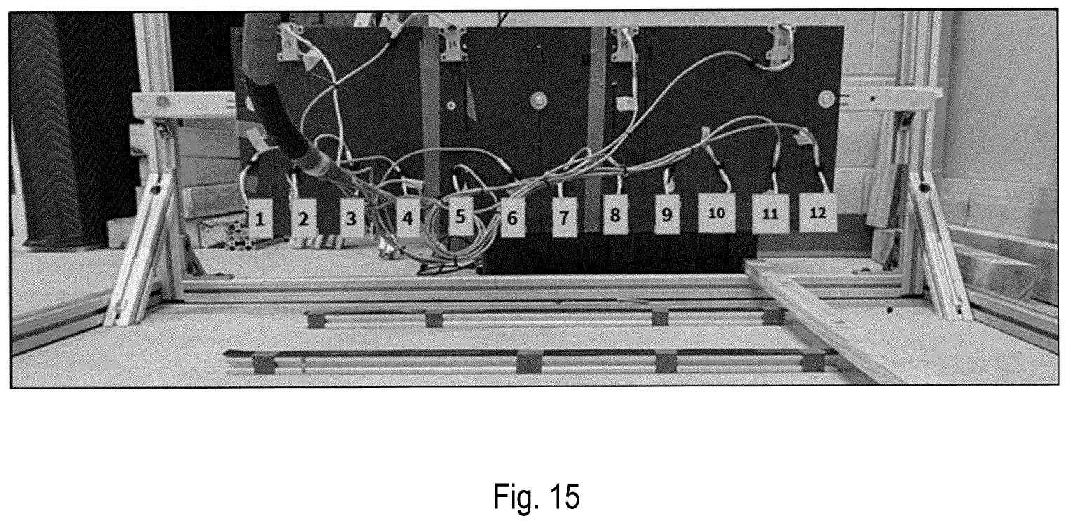

The general schematic for the EM-strip configuration for both longitudinal spacing and inclination-angle variations is shown in FIG. 14. FIG. 15 further shows an actual experimental setup with the reference number of each of a plurality of magnetometer sensors labeled. The corresponding testing factorials are summarized in Table 1 below. The example of the experimental setup when the sensing strips are placed perpendicularly to the sensor arrays (90° degrees) is presented in FIG. 16A, the setup with diagonal placement of the sensing strips (45° degrees) in FIG. 16B. The setups in FIGS. 16A and 16B provide visual representations of the configurations used during experimentation of the setups.

TABLE 1
Testing Factorial and Scenarios for EM
Passive Sensing for SWZ Warning System

| Test | EM-Strip | Inclination Angle |
|---|---|---|
| Scenario No. | Spacing (X), feet | (α), Degrees |
| 1 | 1.0 | 90 |
| 2 | 2.0 | 90 |
| 3 | 1.0 | 45 |
| 4 | 2.0 | 45 |
| 5 | 1.0 | 60 |
| 6 | 2.0 | 60 |
| 7 | 2.0 | 120 |
| 8 | 2.0 | 60 and 90 |

As shown in the examples in Table 1, the spacing (X) of the electromagnetic (EM) strips for the speed-warning system varied from 1 to 2 ft (as adapted to the space limitation in a laboratory setting). During this variation, the inclination angle (a) of the strips is fixed at various options, i.e., the strips are oriented 45°, 60°, 90°, and 120° from the longitudinal direction. By exploring different strip spacings within this range, the performance of the speed-warning system with the EM-based sensor system can be assessed, and the optimal spacing that enhances the system's effectiveness in speed warnings to drivers can be determined. Likewise, the inclination angles of the EM strips for the lane-merge warning system were varied between 45° and 120° while keeping the strip spacing fixed. This procedure allowed for determining the optimal inclination angle to provide accurate lane-merge warnings to drivers in certain example speed range and other conditions.

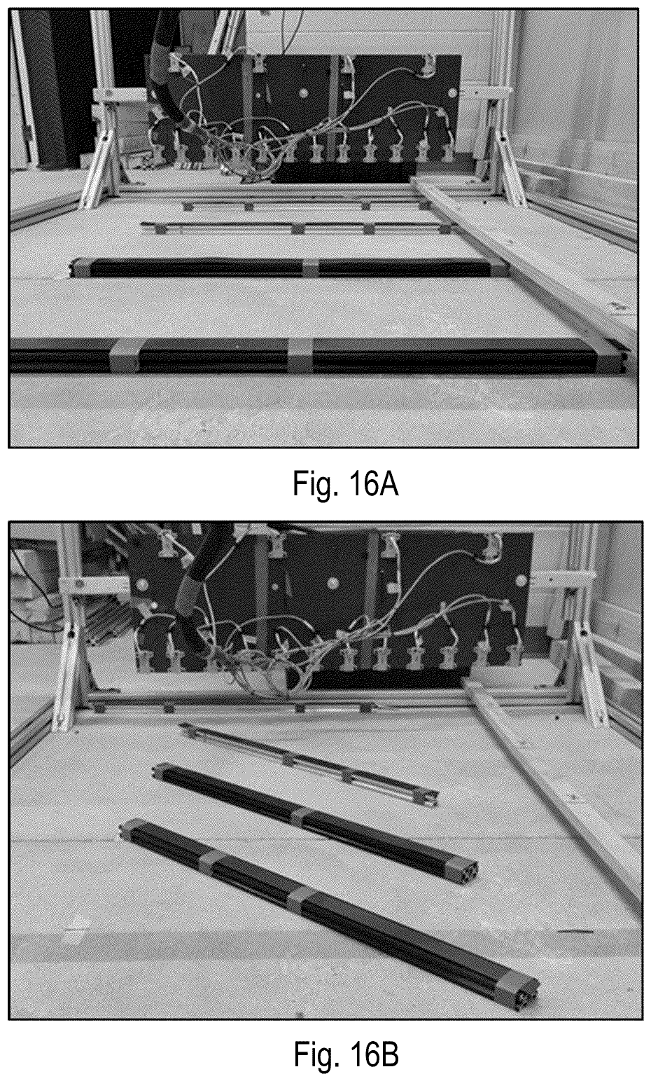

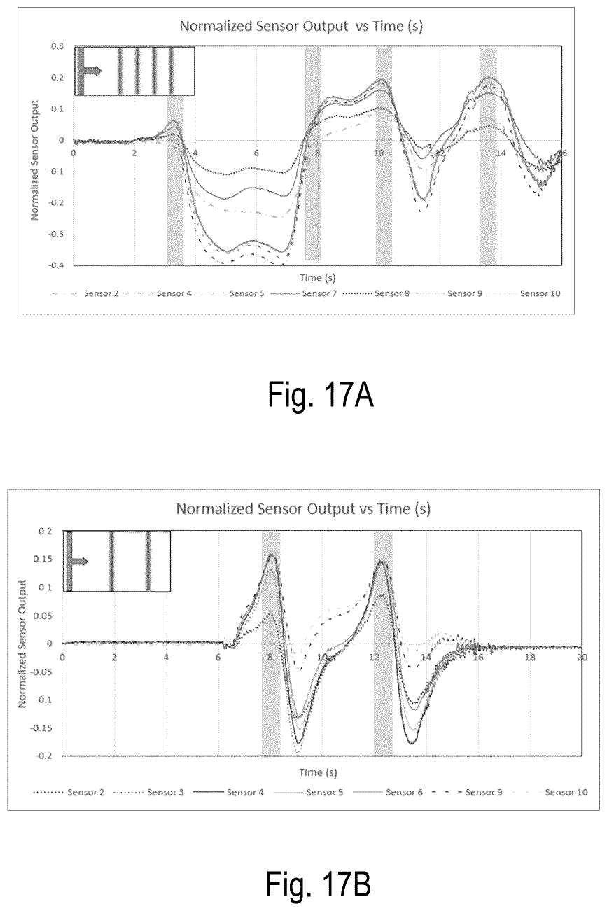

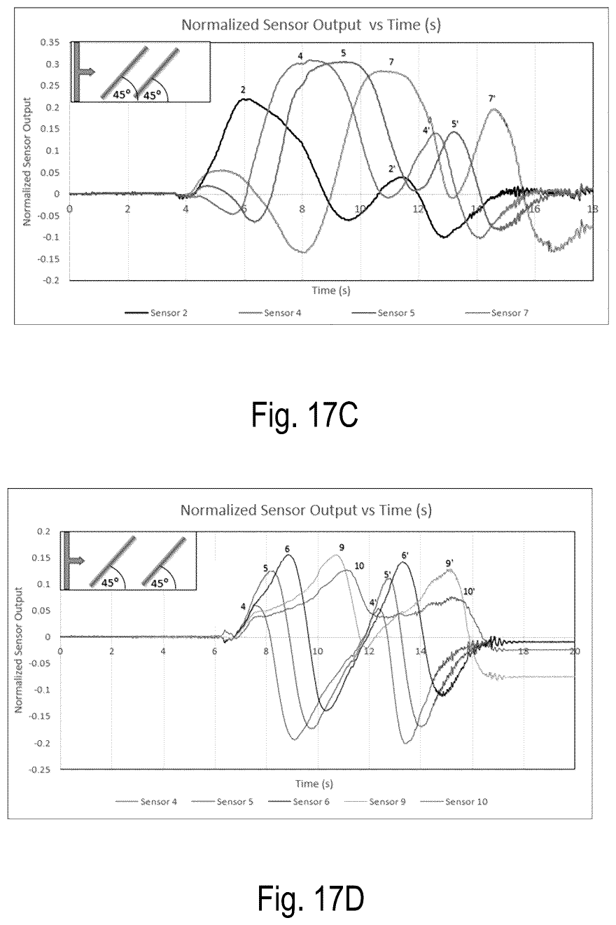

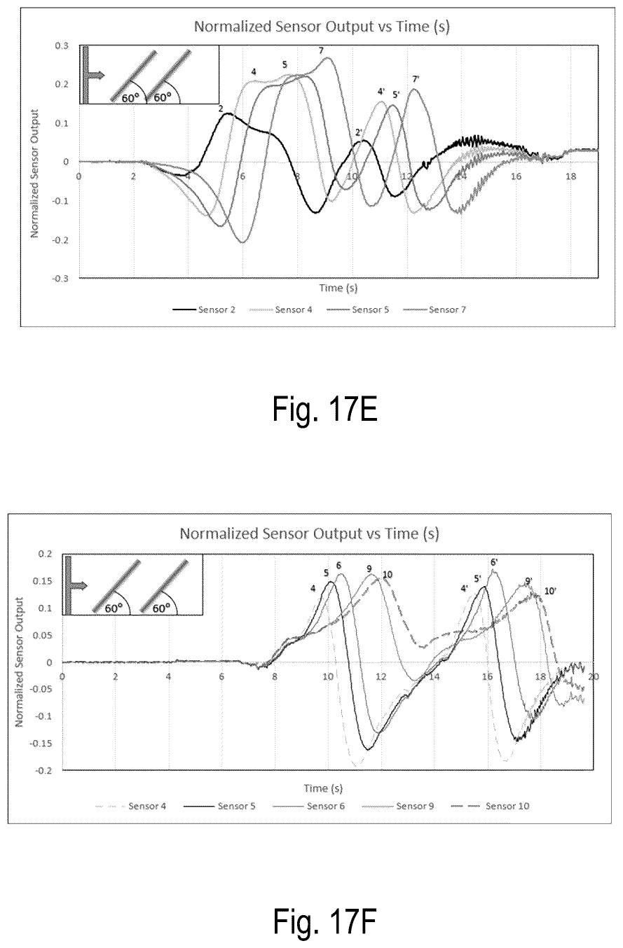

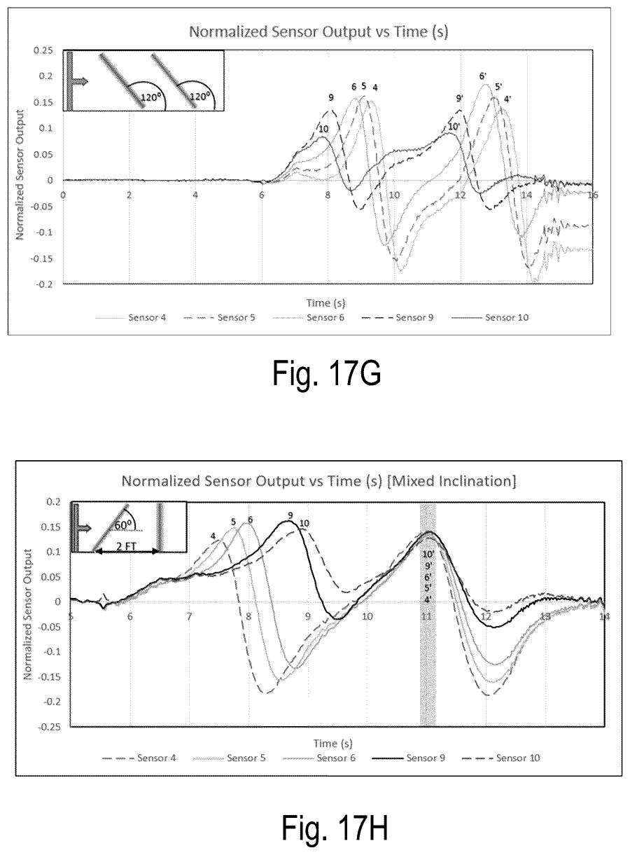

The results for the testing are presented in FIGS. 17A-17H in terms of EM signal as detected by the various sensors. FIGS. 17A-17B are for normal angles. FIGS. 17C-17D are for 45° angled strips. FIGS. 17E-17F and FIG. 17H are for 60° angled strips. FIG. 17G is for 120° angled strips. The normalized EM signatures, after eliminating background noise, exhibited similar trends to the theoretical diagrams presented from FIGS. 10 to 12. The clarity of the EM signals was influenced by the longitudinal strip spacing. The sensing signatures for the 2-ft spacing (FIG. 17B) demonstrated superior clarity, as compared to the sensing signatures of the 1-ft spacing (FIG. 17A), as the EM signature of adjacent EM strips do not significantly overlap in space and the sensors are sufficiently recovered from detecting EM signature as a clear peak from each EM strip and ready to detect a next EM Strip. As the EM-strip spacings are reduced, the electromagnetic field of one strip may be detected simultaneously by a sensor position near an adjacent strip (in other words, the electromagnetic field from neighboring strips may overlap when they are close). As shown in FIG. 17B for the 2-foot spacing, the two EM-sensor strips can be clearly identified. The results also show that the passive-sensing signatures could be used to estimate the moving speed of each “vehicle.” For example, in FIG. 16B, the “vehicle” or magnetometer sensor array is moving at 0.32 mph (mean 2 ft/(12.24-8.02) seconds).

In the testing of the inclined strips at 45° and 60°, as shown in FIG. 17C to FIG. 17F, the experimental results show expected responses from each magnetometer. The sensor arrays successfully captured the EM-signal peak responses at different time steps in the correct order, aligning with the theoretical diagram illustrated in FIGS. 10 and 12. FIGS. 17C and 17E have some spatial interference between consecutive EM-sensor strips, and thus a sensor spacing of 1 ft may be too close for any speed. Based on the 2-ft sensor spacing and 45° and 60° inclination, the “vehicle” speed can be estimated and is 0.31 mph and 0.24 mph for the 45° and 60° inclination, respectively (FIG. 17D and FIG. 17F).

The performance of the system was examined by inclining the sensing strip to 120°. The output of the sensors, as presented in FIG. 17G, exhibited trends similar to 60° but with sensors ordered in the opposite rank. The ranking of the sensors thus may be used to determine left and right merging. The calculated speed for the 120° detection is 0.35 mph.

The responses are also tested for when the placement patterns of the sensing strips are mixed. In this test configuration, the first strip was inclined at 60°; and the second strip was placed 2 ft away from the right boundary of the first strip, perpendicular to the moving direction of the sensor arrays. The experimental results are presented in FIG. 17H. This finding highlights the robustness and adaptability of the system, indicating its effectiveness in detecting and interpreting EM signals regardless of the specific arrangement of the sensing strips, and this small lab trial has shown that EM sensors can be used to detect vehicle speeds and to communicate maneuvers such as merge right or left with in-vehicle messaging. As such, the EM strips may be arranged into complex spatial pattern that are used to code different information that may be detected by the various sensors in the vehicle. These sensors function effectively as a bar code or QR code scanner in some sense to detect information encoded by the EM material pattern on the pavement of the roadway, for construction work zone warning purposes, and for any other road signage and instruction purposes.

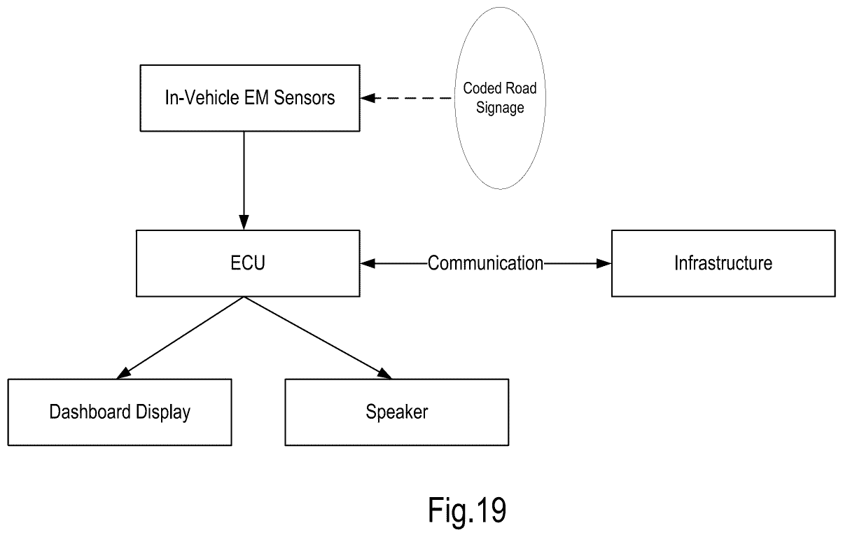

Finally, FIG. 19 shows an example system for implementing in-vehicle roadway warning based on passive sensing discussed above. The system includes in-vehicle EM sensors for detecting EM signatures on coded road signage on the roadways. The detected signal may be analyzed by the ECU of the vehicle to generate speed limit information, and other driving instructions and warnings (e.g., merging instructions). Such information or warning may be provided to an in-vehicle dashboard for display and/or for conversion to audible warning or speech via an in-vehicle speaker. In addition, the measurements by the in-vehicle EM sensors and analysis results by the ECU may be transmitted to an external road safety infrastructure (such as SWZ) via a network (e.g., a wireless network) for further data collection and processing with data collected from other vehicles and devices within the roadway infrastructure.

The various embodiments above, as examples, refer to embedded or surface-installed (e.g., painted) magnetic or magnetized materials as a basis for pavement surface signages. Embedded magnetic materials and surface-installed materials can be used in place of one another. In some example implementations, surface-coated signatures may provide more consistent and robust signal responses compared to embedded signatures (such as steel fibers). Such surface-coated materials may be easier to apply and more compatible with various applications, especially in construction work zones. Other types materials, e.g., materials that generate electric fields, can also be utilized. For another example, the material used may be passive EM field reflectors for passively reflecting EM field originated from the vehicle to the in-vehicle sensors.

It is to be understood that the various implementations above are not limited in its application to the details of construction and the arrangement of components set forth above and in the accompanying drawings. The disclosure is intended to cover other embodiments that may be practiced or carried out in various ways following the underlying principles disclosed herein.

It should also be noted that a plurality of hardware and software-based devices, as well as a plurality of different structural components may be used to implement the various embodiments of the disclosure. In addition, it should be understood that embodiments of this disclosure may include hardware, software, and electronic components or modules that, for purposes of discussion, may be illustrated and described as if the majority of the components are implemented solely in hardware. However, one of ordinary skill in the art, and based on a reading of this disclosure, would recognize that, in at least one embodiment, the electronic based aspects of the invention may be implemented in software (e.g., stored on non-transitory computer-readable medium) executable by one or more processors. As such, it should be noted that a plurality of hardware and software-based devices, as well as a plurality of different structural components may be utilized to implement the invention. Furthermore, and as described in subsequent paragraphs, the specific mechanical configurations illustrated in the drawings are intended to exemplify embodiments of the invention and that other alternative mechanical configurations are possible. For example, “controllers” described in the specification can include standard processing components, such as one or more processors, one or more computer-readable medium modules, one or more input/output interfaces, and various connections (e.g., a system bus) connecting the components. These controllers may be implemented as dedicated processing circuitry or in general-purpose processors, in combination of various software and/or firmware, and in combination of other wired or wireless communication interfaces.

We claim:

1. A method for automatic alert generation in a vehicle on a roadway, comprising:
detecting at least one time-trace of electromagnetic (EM) fields originated or reflected from a surface of the roadway;
extracting at least one notification information item from the at least one time-trace; and
automatically generating an on-vehicle alert according to the notification information item.

2. The method of claim 1, wherein the magnetic fields originated or reflected from a pavement surface signage deployed on the roadway.

3. The method of claim 2, wherein the pavement surface signage comprises a magnetic or magnetized material.

4. The method of claim 3, wherein the magnetic or magnetized material is spatially patterned on the roadway to form the pavement surface signage.

5. The method of claim 4, wherein the pavement surface signage comprises a plurality of strips of the magnetic or magnetized material.

6. The method of claim 5, wherein the plurality of strips are each oriented perpendicular to a traffic flow direction of the roadway.

7. The method of claim 6, wherein the notification information item comprises a speed limit encoded in the pavement surface signage.

8. The method of claim 7, wherein the speed limit is encoded in an inter-strip spacing of the plurality of strips.

9. The method of claim 5, wherein the plurality of strips are each left or right inclined to a traffic flow direction of the roadway.

10. The method of claim 9, wherein the notification information item comprises a merging instruction encoded in the pavement surface signage.

11. The method of claim 10, wherein the at least one time-trace comprises a plurality of time-traces each generated by an in-vehicle magnetic field sensor among a plurality of magnetic field sensors.

12. The method of claim 11, wherein an inclination direction of the plurality of strips are extracted from relative timing of signals in the plurality of time-traces.

13. The method of claim 11, wherein the at least one notification information item further comprises a speed limit encoded in the pavement surface signage.

14. The method of claim 13, wherein the speed limit is encoded in an inter-strip spacing of the plurality of strips.

15. The method of claim 11, wherein the at least one notification information item further comprises an alert for slowing down the vehicle.

16. The method of claim 5, wherein the plurality of strips oriented in both a first direction perpendicular to a traffic flow direction of the roadway and a second direction at a left or right inclined angle to the traffic flow direction.

17. The method of claim 1, wherein the in-vehicle alert is at least displayed on a dashboard of the vehicle.

18. The method of claim 1, wherein the detecting at least one time-trace of the EM fields comprises detecting the EM fields using a plurality of 3-axis sensors.

19. The method of claim 1, wherein the at least one notification information is extracted only when signals from all three dimensions from at least one of the 3-axis sensors are determined as correlated.

20. An in-vehicle alert system comprising:
at least one sensor configured to detect at least one time-trace of EM fields originated or reflected from a pavement surface signage of a roadway;
a processor configured to:
receive the at least one time-trace and to extract at least one notification information item from the at least one time-trace; and
automatically generating an in-vehicle alert according to the notification information item; and
an alerting device for a visual or audible presentation of the in-vehicle alert.
